(19) United States
(12) Patent Application Publication
(10) Pub. No.: US 2005/0055530 A1
(43) Pub. Date: Mar. 10, 2005

(54) METHOD AND APPARATUS FOR PROTECTING A SPECIFIC MEMORY SECTION

(76) Inventors: Yuan-Ting Wu, Hsin-Chu City (TW); Ping-Sheng Chen, Chia-Yi Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,891

(22) Filed: Aug. 11, 2004

(30) Foreign Application Priority Data
Sep. 8, 2003 (TW) 092124749

(51) Int. Cl. G06F 12/08

(52) U.S. Cl. 711/203

(57) ABSTRACT

A method for accessing a memory to protect a memory section from being accessed or changed incorrectly when accessing the memory, the method includes (a) generating a first logic address data, (b) selectively outputting the first logic address data or a second logic address data as physical address data by using an address translator according to a control signal, and (c) accessing the memory according to the physical address data, wherein the second logic address data is a result obtained after operating the first logic address data.

### BACKGROUND

The invention relates to a method and related apparatus for accessing a memory, and more particularly, to a method and related apparatus for protecting a memory section from being accessed or changed incorrectly when accessing a memory.

Electronic devices such as microprocessors and memories play an important role in the modern information-oriented society, and they are widely used in different electronic apparatuses. For example, in a DVD player, CD-ROM drive, CD-RW drive, DVD-ROM drive, there is a microprocessor that executes a program code stored in a non-volatile memory, such as a flash memory or a ROM, to process data stored in a volatile memory, such as a DRAM or an SRAM, in cooperation with an application specific integrated circuit (ASIC).

The microprocessor operates by executing the program code, which is stored in the non-volatile memory and also called firmware. For the reasons of enhancement and improvement and debugging, most firmware need to be updated, which is known as a “firmware update” in short.

A risk of firmware updating is that it may fail due to electric power failure or incorrect operation. Such kind of firmware updating failure causes an extreme system failure to the point that further firmware updating cannot be executed anymore to restore the system. In order to prevent this condition in advance, boot code protection is applied in the related art. A boot code is a part of the firmware program code that is a section of the program code initially executed whenever the system is powered on or rebooted. The related art sets up read protection on a memory section storing the boot code so that it will not be rewritten during firmware update. In such a manner, even if firmware update fails, the system can reboot again by executing the boot code. Boot code protection is well known by the person in the art.

Please refer to FIG. 1 showing a conventional microprocessor system 200. As shown in FIG. 1, the microprocessor system 200 includes a microprocessor 10 and a non-volatile memory 30 (e.g. a flash memory) coupled with the microprocessor 10 via an address bus 20. The non-volatile memory 30 includes a boot code section 32 for storing a boot code, a general firmware section 34 for storing other firmware program codes, and a plurality of pins 36, 37, 38 for switching read protection on the boot code section 32. The microprocessor 10 is used for executing data stored in the non-volatile memory 30.

During a firmware update, the microprocessor 10 transmits a set of address data to the non-volatile memory 30 via the address bus 20 to notify the non-volatile memory 30 that data corresponding to the set of addresses are to be accessed by the microprocessor 10. At this moment, if the boot code section 32 is not under read protection, the microprocessor 10 can completely access any data in the non-volatile memory 30, including the boot code section 32 and the general firmware section 34. If firmware update fails due to power failure or incorrect operation, in order to restore the system, the user is required to reboot the system and re-execute firmware update. However, since data stored in the boot code section 32 may be changed to a point where it is incomplete or incorrect, the system may not be able to be re-booted, and consequently, firmware update cannot be executed.

Therefore during a firmware update, a section of firmware program code is to be protected from change to ensure that the system is able to be restored even after a firmware update fails, the section of firmware program code being called a boot code.

The boot code is stored in the boot code section 32 of the non-volatile memory 30, which can be locked in two manners according to the related art. The first one is to set the electrical levels of some specific pins of the non-volatile memory 30. The position and level setup of these pins depend on the type of the non-volatile memory. For instance, as shown in FIG. 1, the non-volatile memory 30 has a plurality of pins, wherein in that case that the pins 36, 37 are in high level and the pin 38 is in ultrahigh level (12.5V in general), the boot code section 32 of the non-volatile memory 30 is locked. In this case, the data in the boot code section 32 is under read protection so that the microprocessor 10 can only completely access the data in the general firmware section 34, but the microprocessor 10 only have the ability to read but can not write or delete the data in the boot code section 32. Since the boot code is not changed during the firmware update, the microprocessor 10 completes firmware update by only updating the data in the general firmware section 34, and the system can be re-booted by executing the boot code in the boot code section 32 even when the firmware update fails.

The second method is to control the non-volatile memory 30 to lock or unlock the boot code section 32 by using a program command. According to the related art, combinations of specific addresses and values are transmitted to the non-volatile memory 30 in sequence, in several continuous bus program cycles. If the combinations of addresses and values comply with a predetermined content and sequence, the boot code section 32 is locked or unlocked according to a predetermined protocol. The number of continuous bus program cycles, and the specific combination of addresses and values required to be transmitted in each bus program cycle depend on the type of the non-volatile memory 30. For instance, assume that in the microprocessor system 200 shown in FIG. 1, the non-volatile memory 30 is 512 K byte in size with an address range from 00000H to 7FFFFH, wherein the boot code section 32 is 16 K byte in size with an address range from 00000H to 03FFFH, and the address range of the general firmware section 34 is from 04000H to 7FFFFH. In this case, if the combinations of addresses/values of 5555H/AAH, 2AAAH/55H, 5555H/BBH, 3C000H/00H are transmitted to the non-volatile memory 30 in sequence in four continuous bus program cycles, the non-volatile memory 30 unlocks the boot code section 32. In another case, if the combinations of addresses/values of 5555H/AAH, 2AAAH/55H, 5555H/BBH, 3C000H/01H are transmitted to the non-volatile memory 30 in sequence in four continuous bus program cycles, the non-volatile memory 30 locks the boot code section 32. In such a manner, the boot code section 32 can be locked or unlocked.

As described above, the related art protects a specific memory section (i.e. boot code section) by locking it to prevent it from being deleted or updated. After firmware update is completed, regardless of whether it is successful or not, the boot code stored in the specific memory section will always be executed first so that even if firmware update fails, the system can be restored by executing the boot code. Such a kind of method has several disadvantages as follows:
(1) A special non-volatile memory for supporting read protection on a specific memory section is required, therefore restricting the design of hardware.
(2) The method of switching the read protection on the specific memory section is different in different memories manufactured by different makers, which further complicates the system design and raises the cost.
(3) The protected memory section is fixed and different in different memories manufactured by different makers, meaning that is unable to be changed.
(4) The specific memory section can still be read by the microprocessor, thus incorrect execution, incorrect access, incorrect deletion or incorrect erasing or update is still possible.

### SUMMARY OF INVENTION

It is therefore a primary objective of the claimed invention to provide a method and related apparatus for protecting a memory section from being accessed or changed incorrectly when accessing a memory.

Briefly, a method for accessing a memory to protect a memory section from being accessed or changed incorrectly when accessing the memory, the method includes (a) generating a first logic address data, (b) outputting selectively the first logic address data or a second logic address data as a physical address data by using an address translator according to a control signal, and (c) accessing the memory according to the physical address data, wherein the second logic address data is a result obtained after operating the first logic address data.

The present invention further provides a microprocessor system for accessing a memory, which includes a microprocessor for providing first logic address data, a memory comprising a first memory section and a second memory section, and an address translator coupled between the microprocessor and the memory to selectively output the first logic address data or second logic address data as physical address data.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a conventional microprocessor system.

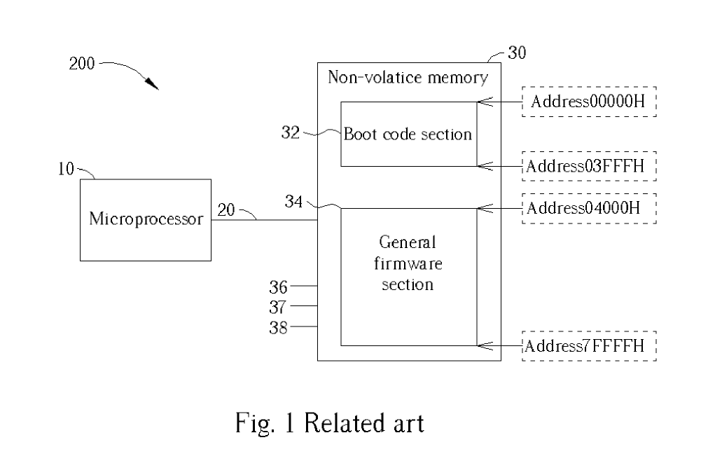

FIG. 2 illustrates a microprocessor system according to the present invention.

FIG. 3 is a flowchart of accessing a memory according to the present invention.

### DETAILED DESCRIPTION

In computer science, all combinations of addressable units that can be accessed by a microprocessor are called address spaces. An address space can be divided into either a memory space or an I/O space according to different characteristics. Memory cells or I/O units that do not exist in the address space cannot be accessed by the microprocessor. According to such kind of characteristics, the present invention provides a method to have a boot code section exist or not exist in the address space of the microprocessor as required by modifying an address decoding of the microprocessor in order to protect the boot code section.

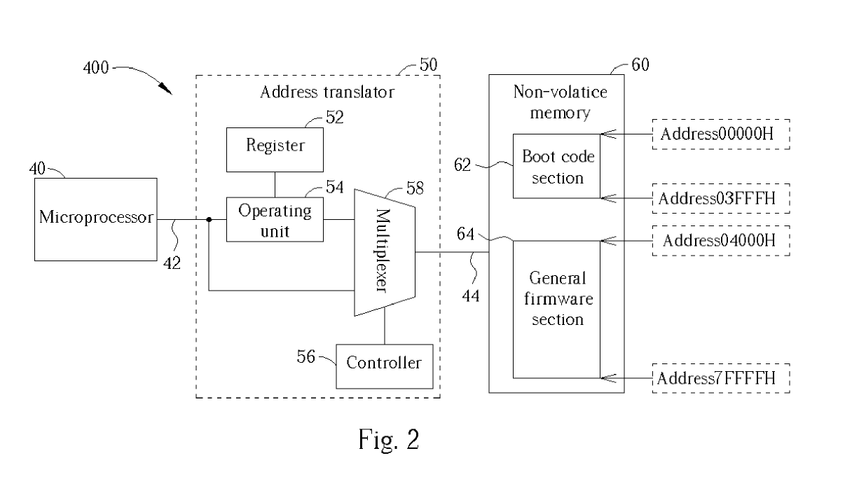

Please refer to FIG. 2 showing a microprocessor system 400 according to the present invention. The microprocessor system 400 includes a microprocessor 40, an address translator 50 coupled with the microprocessor 40 via a first address bus 42 for processing first logic address data output from the microprocessor 40 and generating physical address data, and a non-volatile memory 60 including a boot code section 62 and a general firmware section 64 and coupled with the address translator 50 via a second address bus 44 for receiving the physical address data from the address translator 50. The non-volatile memory 60 addresses the data according to the physical address data received for the microprocessor 40 to access.

In a preferred embodiment of the present invention, the address translator 50 includes a register 52 for storing a setup value representing a characteristic (e.g. size of address space) of the boot code section 62, an operating unit 54 coupled with the register 52 and the first address bus 42 for processing the first logic address data according to the setup value in order to generate the second logic address data, a controller 56 for providing a control signal, and a multiplexer 58 having a first input end coupled with an output end of the operating unit 54, a second input end coupled with the first address bus 42, a selection end coupled with the controller 56 in order to receive the control signal, and an output end coupled with the second address bus 44 in order to output the physical address data to the non-volatile memory 60 via the second address bus 44.

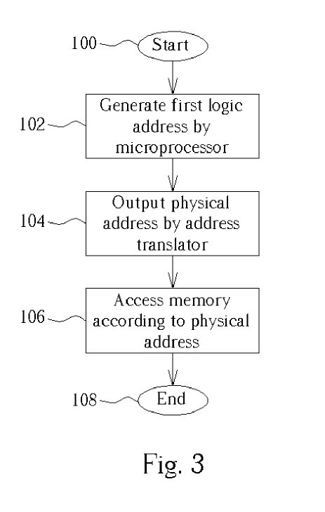

Please refer to FIG. 3 showing a flowchart of accessing a memory according to the present invention as follows:
Step 100: Start
Step 102: Generate the first logic address data by the microprocessor.
Step 104: Output selectively the first logic address data or the second logic address data as the physical address data by using the address translator according to the control signal.
Step 106: Access the memory according to the physical address data.
Step 108: End.

In order to describe the method shown in FIG. 3, please refer to FIG. 2. Assume that in the microprocessor system 400 shown in FIG. 2, the non-volatile memory 60 is 512 Kbyte in size with an address range from 00000H to 7FFFFH, wherein the boot code section 62 is 16 Kbyte in size with an address range from 00000H to 03FFFH, and the general firmware section 64 is 496 Kbyte in size with an address range from 04000H to 7FFFFH.

In the preferred embodiment of the present invention, in Step 102, the microprocessor 40 generates the first logic address data (assumed to be 00000H) to indicate a data address in the non-volatile memory 60 and then transmits the first logic address data to the operating unit 54 and the second input end of the multiplexer 58 via the first address bus 42 before then proceeding to Step 104.

For a clearer description, assume the setup value stored in the register 52 to be the 04000H of the boot code section 62.

In Step 104, the operating unit 54 of the address translator 50 is an adder. The operating unit 54 adds the setup value (04000H) to the first logic address data (00000H), which results in the second logic address data (04000H). Then the second logic address data is transmitted to the first input end of the multiplexer 58. The multiplexer 58 multiplexes the first logic address data and the second logic address data according to the control signal received from the controller 56 via its selection end.

If the control signal is an enable signal, the multiplexer 58 selects the second logic address data to output as the physical address data, which in this case is 04000H. And then in Step 106, the non-volatile memory 60 addresses the data according to the physical address data (04000H) to complete the data stored at 04000H (in the general firmware section 64) for the microprocessor 40 to access. On the other hand, if the control signal is a disable signal, the multiplexer 58 selects the first logic address data (00000H) to output as the physical address data, which in this is 00000H. And then in Step 106, the non-volatile memory 60 addresses the data according to the physical address data (00000H) to complete the data stored at 00000H (in the boot code section 62) for the microprocessor 40 to access.

As described above, if the controller generates the enable signal, the multiplexer 58 outputs physical address data that is different from the first logic address data, and if the controller generates the disable signal, the multiplexer 58 outputs physical address data that is the same as the first logic address data. In other words, when the controller generates the enable signal, the address translator 50 translates the first logic address data generated by the microprocessor 40.

Therefore, the address translator 50 can be switched on and off by controlling the controller 56 to generate different control signals. In the case of turning on the address translator 50, the boot code section 62 can be regarded as not existing in the accessible address space of the microprocessor 40. This is because the first logic address data is shifted by the address translator 50 with an amount equal to the size of the boot code section 62. Thus the microprocessor 40 cannot access the data in the boot code section 62 nor delete or update them. Therefore, the data in the boot code section 62 is safe from being accessed, deleted, or updated incorrectly when the address translator 50 is turned on.

In addition, although it is assumed that the boot code section 62 of the non-volatile memory 60 is 16 Kbyte in size in the embodiment described above, that does not mean that the boot code stored inside is necessarily 16 Kbyte in size. For instance, assume that the firmware program code (i.e. the boot code) stored in the boot code section 62 is 12 Kbyte in size, leaving 4 Kbyte of unused space in the boot code section 62. In order to increase the efficiency of the non-volatile memory 60, the unused space of 4 Kbyte in the boot code section 62 is released to the general firmware section 64 to store more firmware code. In order to reduce the size of the boot code section 62 that is to be protected shown in the embodiment in FIG. 3, the address translator 50 can simply change the setup value stored in the register 52 to reduce the size of the protected memory section and in doing so, release the unused space to store more firmware code.

As described above, the boot code is actually 12 Kbyte in size, meaning that only 12 Kbyte of the boot code section 62 is required. In this case, change the setup value in the register 52 to 03000H (i.e. the size of the required part of the boot code section 62 is 03000H). In Step 102, the microprocessor 40 generates the first logic address data of 00000H and transmits the first logic address data to the operating unit 54 and the second input end of the multiplexer 58 via the first address bus 42. And then proceed Step 104.

In Step 104, the operating unit 54 of the address translator 50 adds the new setup value (03000H) to the first logic address data (00000H), which results in the second logic address data (03000H). Then the second logic address data is transmitted to the first input end of the multiplexer 58. The multiplexer 58 multiplexes the first logic address data and the second logic address data according to the control signal received from the controller 56 via its selection end. If the control signal is an enable signal (which means to turn on the address translator 50), the multiplexer 58 selects the second logic address data (03000H) to output as the physical address data, which in this case is 03000H. And then in Step 106, the non-volatile memory 60 addresses the data according to the physical address data (03000H) to complete the data stored at 03000H for the microprocessor 40 to access.

Please notice that address 03000H originally belonged to the boot code section 62; however, the microprocessor 40 can access the data at that address even if the address translator 50 is turned on, which means address 03000H in the non-volatile memory 60 is an address space of the microprocessor 40. In this way, even if the address translator 50 is turned on, the section from address 03000H to 03FFFH in the non-volatile memory 60 is an address space of the microprocessor 40.

Hence, in the case that the address translator 50 is turned on, the required part of the boot code section 62 for storing the boot code of 12 Kbyte is from address 00000H to 02FFFH, which is 12 Kbyte in size, and not within the address space of the microprocessor 40. This means that the last 4 Kbyte of the original 16 Kbyte of the boot code section 62 is released to into the general firmware section 64. Similarly, if the boot code is 20 Kbyte in size, a boot code section with 20 Kbyte in size can be provided simply by changing the setup value into 20 Kbyte.

As described above, the size of the boot code section 62 is limited by the design of makers and cannot be adjusted in the related art. In contrast, the boot code section 62 is adjustable through changing the setup value stored in the register 52 in the present invention.

A further description of the microprocessor system 400 shown in FIG. 3 used in different conditions is hereby presented.

When the power is on or restored, in order to have the microprocessor 40 execute the boot code stored in the boot code section 62 to boot the system, turn off the address translator 50 to have the boot code section 62 exist in the address space of the microprocessor 40.

When the processor 40 starts executing general firmware code, the boot code must have been completely executed and the system is successfully booted. In order to prevent the boot code section 62 from being accessed, erased or changed incorrectly, the microprocessor 40 executes a command predetermined in the last part of the boot code to have the controller 56 output the enable signal in order to turn on the address translator 50. As described above, in this case the boot code section 62 does not exist in the address space of the microprocessor 40; thus it is not possible for the boot code stored in the boot code section 62 to be accessed nor erased or changed incorrectly by the microprocessor 40.

When it is required to access, erase or update (such as a firmware update) the boot code section 62, in order to have the microprocessor 40 write the updated boot code into the boot code section 62 to replace the original one, turn off the address translator 50. As described above, in this case the boot code section 62 and the general firmware section 64 both exist in the address space of the microprocessor 40; thus the data stored in the boot code section 62 can be accessed, erased or changed by the microprocessor 40.

Similarly in the preferred embodiment of the present invention, the operating unit 54 being an adder is only an example. It can be also other operating circuits such as a subtracter. For instance, if the boot code section 62 to be protected is located in the last section of the non-volatile memory 60, the operating unit 54 can subtract the first logic address data from the initial address of the boot code section 62. Any other operating units, which can implement the present invention belong to the range thereof.

In summary, the characteristics of the present invention are: (1) the non-volatile memory is not required to be able to lock the boot code section; however, the present invention can be of course applied in non-volatile memories having that function, (2) the microprocessor system uses the address translator to protect a specific memory section of the non-volatile memory, and (3) the specific memory section can be changed in size by modifying the setup value of the address translator.

Those skilled in the art will readily observe that numerous modifications and alterations of the device and method may be made while retaining the teachings of the invention. Accordingly, the above disclosure should be construed as limited only by the metes and bounds of the appended claims.

1. A method for accessing a memory to protect a memory section from being accessed or changed incorrectly when accessing the memory comprising:
(a) generating a first logic address data;
(b) selectively outputting the first logic address data or a second logic address data as a physical address data by using an address translator according to a control signal; and
(c) accessing the memory according to the physical address data;
wherein the second logic address data is a result obtained after operating the first logic address data.

2. The method of claim 1 wherein Step (b) further comprises operating the first logic address data by using the address translator according to a setup value in order to generate the second logic address data.

3. The method of claim 2 wherein the setup value is a value representing a characteristic of the memory section.

4. The method of claim 2 wherein the setup value is stored in a register.

5. The method of claim 2 wherein the address translator further comprises an operating unit, and Step (b) further comprises operating the first logic address data by using the operating unit according to the setup value to generate the second logic address data.

6. The method of claim 2 wherein the address translator further comprises a multiplexer, and Step (b) further comprises multiplexing the first logic address data and the second logic address data by using the multiplexer to selectively output the first logic address data or the second logic address data.

7. A microprocessor system for accessing a memory comprising:
a microprocessor for providing a first logic address data;
a memory comprising a first memory section and a second memory section; and
an address translator coupled between the microprocessor and the memory to selectively output the first logic address data or a second logic address data as a physical address data;
wherein the second logic address data is a result obtained after operating the first logic address data and the microprocessor accesses data of the first memory section or the second memory section according to the physical address data.

8. The device of claim 7 wherein the memory is a non-volatile memory.

9. The device of claim 7 wherein the address translator operates the first logic address data according to a setup value to generate the second logic address data.

10. The device of claim 9 wherein the setup value is a value representing a characteristic of the first memory section.

11. The device of claim 9 wherein the address translator further comprises an operating unit to operate the first logic address data according to the setup value in order to generate the second logic address data.

12. The device of claim 9 wherein the address translator further comprises a register for storing the setup value.

13. The device of claim 7 wherein the address translator further comprises a multiplexer for multiplexing the first logic address data and the second logic address data in order to selectively output the first logic address data or the second logic address data.
